(19) United States
(12) Patent Application Publication
(10) Pub. No.: US 2020/0052342 A1
(43) Pub. Date: Feb. 13, 2020

(54) LITHIUM-ION RECHARGEABLE BATTERY

(71) Applicants: SHOWA DENKO K.K., Tokyo (JP); SHOWA DENKO PACKAGING CO., LTD., Isehara-shi, Kanagawa (JP)

(72) Inventors: Takaki YASUDA, Ichihara-shi, Chiba (JP); Isao KABE, Ichihara-shi, Chiba (JP); Koji MINAMITANI, Isehara-shi, Kanagawa (JP); Kensuke NAGATA, Isehara-shi, Kanagawa (JP)

(73) Assignees: SHOWA DENKO K.K., Tokyo (JP); SHOWA DENKO PACKAGING CO., LTD., Isehara-shi, Kanagawa (JP)

(21) Appl. No.: 16/608,616

(22) PCT Filed: Jan. 31, 2018
(86) PCT No.: PCT/JP2018/003132

§ 371 Date: Oct. 25, 2019

(30) Foreign Application Priority Data
Apr. 26, 2017 (JP) 2017-087508

(51) Int. Cl. H01M 10/0585; H01M 10/0525; H01M 2/08

(52) U.S. Cl. CPC H01M 10/0585; H01M 2/08; H01M 10/0525

(57) ABSTRACT

A lithium-ion rechargeable battery (1) provided with: a battery unit (100) including a metal substrate (10) and a battery part (20) configured by laminating thin films on the substrate (10); and a shell (200) provided on the surface of the substrate (10), on which the battery part (20) is formed, to seal the substrate (10) and the battery unit (100). The shell (200) includes a laminated film (30) formed by laminating a metal layer (33) and various types of resin layers. Consequently, the thickness of the thin-film type lithium-ion rechargeable battery including a solid electrolyte is reduced.

### TECHNICAL FIELD

The present invention relates to a lithium-ion rechargeable battery.

### BACKGROUND ART

A lithium-ion rechargeable battery, which is provided with: a battery part including a positive electrode containing a positive-electrode active material, a negative electrode containing a negative-electrode active material, and an electrolyte having lithium-ion conductivity and interposed between the positive electrode and the negative electrode; and a shell that houses the battery part to seal the battery part against outside air or the like, is known.

The shell of the lithium-ion rechargeable battery is required to have high barrier properties against gases, liquids and solids. In Patent Document 1, it is described that a shell is configured by using a laminated shell material formed by laminating a metallic foil layer and a thermo-adhesive resin layer and by thermally adhering thermo-adhesive films to each other.

Moreover, as the electrolyte constituting the battery part, an organic electrolytic solution or the like has been conventionally used. In contrast thereto, in Patent Document 2, it is described that a solid electrolyte made of an inorganic material is used as the electrolyte, and all of the negative electrode, the solid electrolyte and the positive electrode are configured with thin films.

### CITATION LIST

### Patent Literature

### Patent Document 1: Japanese Patent Application Laid-Open Publication No. 2016-129091

### Patent Document 2: Japanese Patent Application Laid-Open Publication No. 2013-73846

### SUMMARY OF INVENTION

### Technical Problem

Here, when a lithium-ion rechargeable battery is configured by using a battery part of the thin-film type and a pouch-shaped shell to house the battery part inside thereof, the constituent material of the shell (laminated shell material or the like) is on each of the front and back surfaces of the battery part. Therefore, there is a possibility that the thickness of the lithium-ion rechargeable battery to be obtained is increased.

An object of the present invention is to reduce a thickness of a thin-film type lithium-ion rechargeable battery including a solid electrolyte.

### Solution to Problem

A lithium-ion rechargeable battery according to the present invention includes: a battery part including a positive electrode layer containing a positive-electrode active material, a negative electrode layer containing a negative-electrode active material, and a solid electrolyte layer containing an inorganic solid electrolyte having lithium-ion conductivity, the solid electrolyte layer being provided between the positive electrode layer and the negative electrode layer; a substrate on one surface of which the battery part is placed; and a laminated film including a metal layer and a resin layer laminated on the metal layer disposed to face the one surface of the substrate, the laminated film sealing the battery part with the substrate in a state in which the metal layer and the battery part are brought into conduction.

In such a lithium-ion rechargeable battery, the substrate is thicker than the metal layer of the laminated film.

Moreover, a part of the metal layer in the laminated film is exposed without being covered with the resin layer.

Further, the positive electrode layer provided to the battery part and the metal layer provided to the laminated film are in direct contact with each other.

Moreover, from another standpoint, a lithium-ion rechargeable battery according to the present invention includes: a battery part including: a positive electrode layer containing a positive-electrode active material; a negative electrode layer containing a negative-electrode active material; and a solid electrolyte layer containing an inorganic solid electrolyte having lithium-ion conductivity, the solid electrolyte layer being provided between the positive electrode layer and the negative electrode layer; and a sealing part including: a substrate on one surface of which the battery part is placed, the substrate being integrated with the battery part; and a laminated film formed by laminating a metal layer and a resin layer, the sealing part sealing the battery part with the substrate by holding the battery part with the substrate in a state in which the metal layer and the battery part are brought into conduction.

### Advantageous Effects of Invention

According to the present invention, it is possible to reduce the thickness of the thin-film type lithium-ion rechargeable battery including the solid electrolyte.

### BRIEF DESCRIPTION OF DRAWINGS

FIGS. 1A and 1B are diagrams for illustrating an overall configuration of a lithium-ion rechargeable battery of Exemplary embodiment 1;

FIG. 2 is a diagram showing a cross-sectional configuration of the lithium-ion rechargeable battery of Exemplary embodiment 1, which is a II-II cross-sectional view of FIG. 1A;

FIGS. 3A and 3B are perspective views of a battery unit of Exemplary embodiment 1;

FIGS. 4A and 4B are perspective views of a laminated film;

FIG. 5 is a flowchart for illustrating a method for manufacturing the lithium-ion rechargeable battery;

FIG. 6 is a diagram showing a cross-sectional configuration of a modified example of Exemplary embodiment 1, which is a II-II cross-sectional view of FIG. 1A;

FIGS. 7A and 7B are perspective views of a battery unit in the modified example of Exemplary embodiment 1;

FIGS. 8A and 8B are diagrams for illustrating an overall configuration of a lithium-ion rechargeable battery of Exemplary embodiment 2;

FIG. 9 is a diagram showing a cross-sectional configuration of the lithium-ion rechargeable battery of Exemplary embodiment 2, which is a IX-IX cross-sectional view of FIG. 8A; and

FIGS. 10A and 10B are perspective views of a battery unit of Exemplary embodiment 2.

### DESCRIPTION OF EMBODIMENTS

Hereinafter, exemplary embodiments according to the present invention will be described in detail with reference to attached drawings. Note that the size, thickness or the like of each component in the drawings referenced in the following description will differ from the actual dimensions in some cases.

### Exemplary Embodiment 1

### [Configuration of Lithium-Ion Rechargeable Battery]

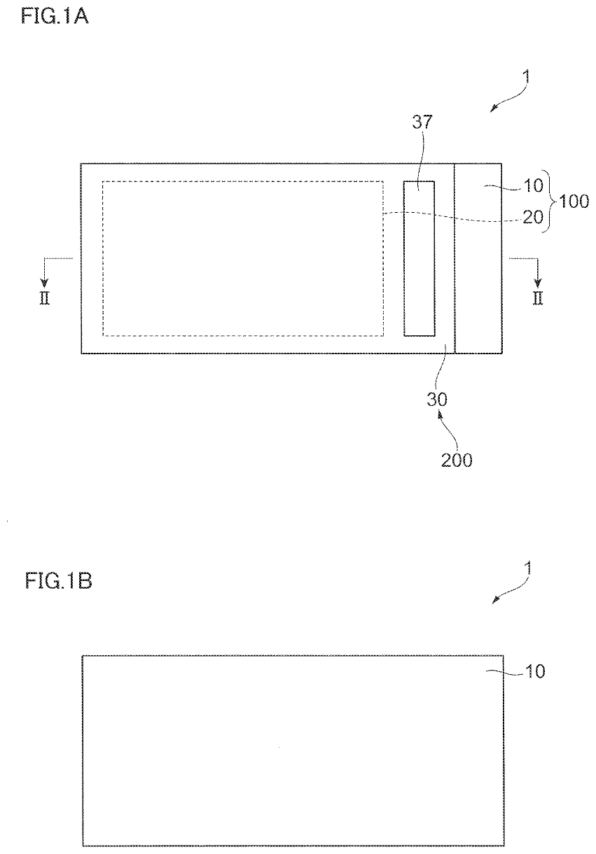

FIGS. 1A and 1B show diagrams for illustrating an overall configuration of a lithium-ion rechargeable battery 1 to which Exemplary embodiment 1 is applied. Here, FIG. 1A is a diagram in which the lithium-ion rechargeable battery 1 is viewed from the front (the front surface), and FIG. 1B is a diagram in which the lithium-ion rechargeable battery 1 is viewed from the back (the back surface).

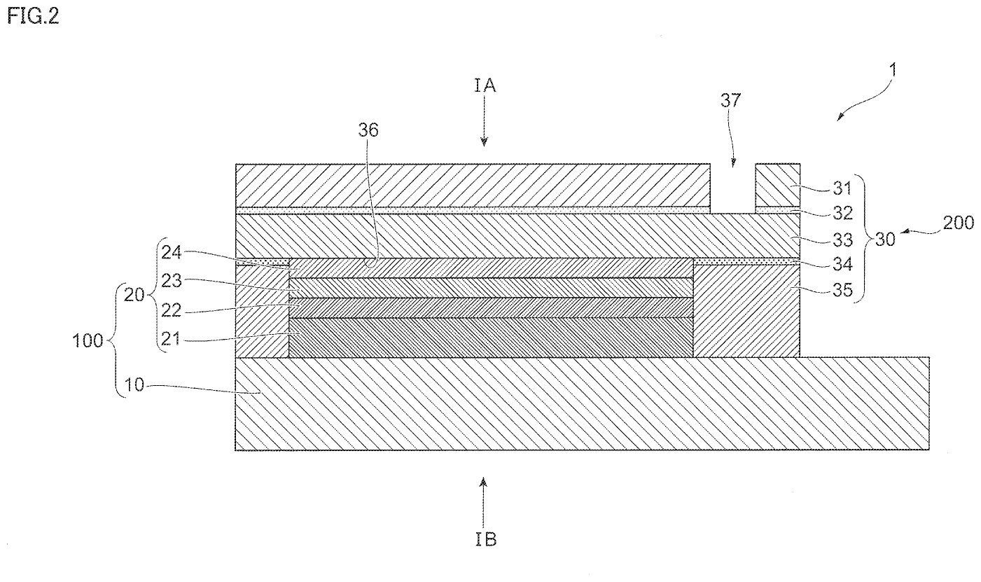

Moreover, FIG. 2 shows a II-II cross-sectional view of FIG. 1A. Note that FIG. 1A is a diagram viewing FIG. 2 from the IA direction, and FIG. 1B is a diagram viewing FIG. 2 from the IB direction.

The lithium-ion rechargeable battery 1 of the exemplary embodiment includes: a battery unit 100 including a battery part 20 that performs charge and discharge using lithium ions; and a shell 200 that seals the battery part 20 against outside air or the like by housing the battery part 20 in the interior thereof. The lithium-ion rechargeable battery 1 of the exemplary embodiment shows a rectangular-parallelepiped shape (in actuality, a card shape) as a whole.

### [Configuration of Battery Unit]

The battery unit 100 includes: a substrate 10 that functions as one electrode (here, a negative electrode) in the lithium-ion rechargeable battery 1; and a battery part 20 provided to one surface (referred to as a front surface) of the substrate 10. In the exemplary embodiment, as will be described later, since the battery part 20 is formed on the front surface of the substrate 10 by a sputtering method, the battery unit 100 has a configuration integrating the substrate 10 and the battery part 20.

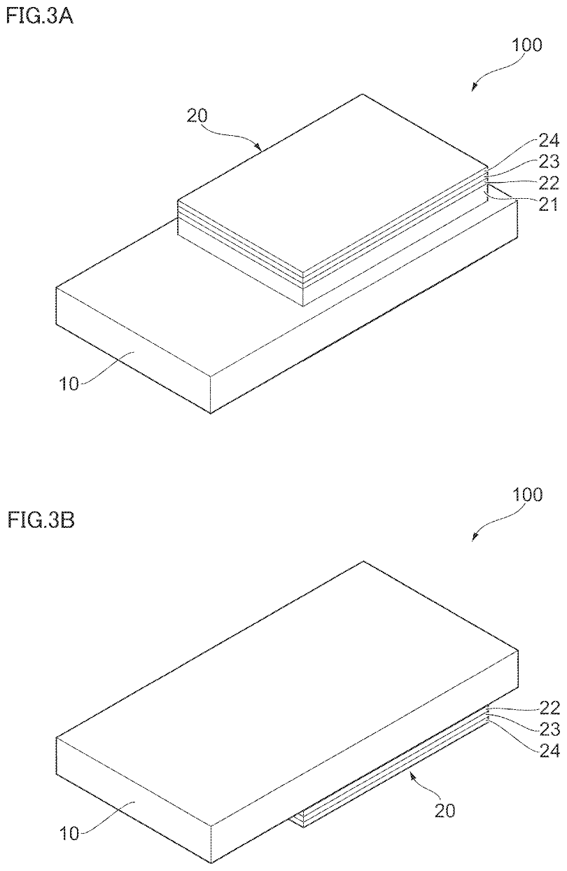

FIGS. 3A and 3B show diagrams for illustrating the configuration of the battery unit 100 in the exemplary embodiment: FIG. 3A shows a perspective view that is viewed from the front side (in FIG. 2, from above); and FIG. 3B shows a perspective view that is viewed from the back side (in FIG. 2, from below). Hereinafter, the configuration of the battery unit 100 will be described with reference to FIGS. 3A and 3B in addition to FIGS. 1A, 1B and 2.

### [Substrate]

As the substrate 10, not to be particularly limited, those configured with various materials, such as metals, glass, ceramics and so on can be used.

In the exemplary embodiment, the substrate 10 was, for the purpose of functioning as the negative electrode collector layer in the lithium-ion rechargeable battery 1, configured with a plate material made of metal having electron conductivity. Here, considering that the substrate 10 is used for forming the battery part 20 by the sputtering method, it is preferable to use a stainless steel substrate having high mechanical strength. Moreover, a metal plate, which is obtained by plating with conductive metals, such as nickel, tin, copper, chrome and the like, may be used. In the exemplary embodiment, as the substrate 10, a stainless steel substrate was used.

The thickness of the substrate 10 can be set at 50 μm or more and 200 μm or less. When the thickness of the substrate 10 is less than 50 μm, it becomes difficult to deal therewith in deposition by sputtering, and in addition, the electrical resistance value when being used as the positive electrode is increased. On the other hand, when the thickness of the substrate 10 exceeds 200 μm, a volume energy density and a weight energy density are reduced by the increases in the thickness and the weight of the battery. Moreover, flexibility of the battery is reduced. In the exemplary embodiment, the thickness of the substrate 10 was set at 50 μm.

### [Battery Part]

The battery part 20 includes: a negative electrode layer 21 laminated on the front surface (the upper side in FIG. 2) of the substrate 10; a solid electrolyte layer 22 laminated on the negative electrode layer 21; a positive electrode layer 23 laminated on the solid electrolyte layer 22; and a positive electrode collector layer 24 laminated on the positive electrode layer 23. Here, the negative electrode layer 21 positioned on one end portion of the battery part 20 (the lower side in FIG. 2) is in contact with the front surface of the substrate 10. In contrast thereto, the positive electrode collector layer 24 positioned on the other end portion of the battery part 20 (the upper side in FIG. 2) is in contact with a metal layer 33 provided to a laminated film 30, which will be described later.

Now, each constituent of the battery part 20 will be described in more detail.

### (Negative Electrode Layer)

The negative electrode layer 21 is not particularly limited as long as the layer is a solid thin film and contains a negative-electrode active material occluding and releasing lithium ions with a negative polarity, and, for example, carbon (C) or silicon (Si) can be used. In the exemplary embodiment, as the negative electrode layer 21, silicon (Si) doped with boron (B) was used.

The thickness of the negative electrode layer 21 can be set at, for example, 10 nm or more and 40 μm or less. When the thickness of the negative electrode layer 21 is less than 10 nm, the capacity of the battery part 20 to be obtained becomes too small, and impractical. On the other hand, when the thickness of the negative electrode layer 21 exceeds 40 μm, it takes too much time to form the layer, and thereby, the productivity is deteriorated. In the exemplary embodiment, the thickness of the negative electrode layer 21 was set at 100 nm.

Moreover, it does not matter whether the negative electrode layer 21 includes crystal structures or is in the amorphous state without including the crystal structures; however, in the point that expansion and contraction associated with occluding and releasing lithium ions are more isotropic, it is preferable that the negative electrode layer 21 is in the amorphous state.

Further, as the manufacturing method of the negative electrode layer 21, known deposition methods, such as various kinds of PVD (physical vapor deposition) or various kinds of CVD (chemical vapor deposition), may be used; however, in terms of production efficiency, it is desirable to use the sputtering method (sputtering).

### (Solid Electrolyte Layer)

The solid electrolyte layer 22 is not particularly limited as long as being a solid thin film including an inorganic material (inorganic solid electrolyte) having lithium-ion conductivity, and those configured with various kinds of materials, such as oxides, nitrides or sulfides, may be used.

In the exemplary embodiment, as the solid electrolyte layer 22, LiPON (LiₓPO_{y}N_{z}), which was obtained by replacing a part of oxygen in Li₃PO₄ with nitrogen, was used.

The thickness of the solid electrolyte layer 22 can be set at, for example, 10 nm or more and 10 μm or less. When the thickness of the solid electrolyte layer 22 is less than 10 nm, in the obtained battery part 20, leakage between the negative electrode layer 21 and the positive electrode layer 23 is likely to occur. On the other hand, when the thickness of the solid electrolyte layer 22 exceeds 10 μm, the moving distance of lithium ions is elongated, and thereby, the charge and discharge rate is reduced. In the exemplary embodiment, the thickness of the solid electrolyte layer 22 was set at 200 nm.

Moreover, it does not matter whether the solid electrolyte layer 22 includes crystal structures or is in the amorphous state without including the crystal structures; however, in the point that expansion and contraction due to heat are more isotropic, it is preferable that the solid electrolyte layer 22 is in the amorphous state.

Further, as the manufacturing method of the solid electrolyte layer 22, known deposition methods, such as various kinds of PVD or various kinds of CVD, may be used; however, in terms of production efficiency, it is desirable to use the sputtering method.

### (Positive Electrode Layer)

The positive electrode layer 23 is not particularly limited as long as the layer is a solid thin film and contains a positive-electrode active material occluding and releasing lithium ions with a positive polarity, and, for example, those configured with various kinds of materials, such as oxides, sulfides or phosphorus oxides containing at least one kind of metal selected from manganese (Mn), cobalt (Co), nickel (Ni), iron (Fe), molybdenum (Mo) and vanadium (V), may be used. In the exemplary embodiment, as the positive electrode layer 23, Li_{1.5}Mn₂O₄ was used.

The thickness of the positive electrode layer 23 can be set at, for example, 10 nm or more and 40 μm or less. When the thickness of the positive electrode layer 23 is less than 10 nm, the capacity of the battery part 20 to be obtained becomes too small, and impractical. On the other hand, when the thickness of the positive electrode layer 23 exceeds 40 μm, it takes too much time to form the layer, and thereby, the productivity is deteriorated. In the exemplary embodiment, the thickness of the positive electrode layer 23 was set at 600 nm.

Moreover, it does not matter whether the positive electrode layer 23 includes crystal structures or is in the amorphous state without including the crystal structures; however, in the point that expansion and contraction associated with occluding and releasing lithium ions are more isotropic, it is preferable that the positive electrode layer 23 is in the amorphous state.

Further, as the manufacturing method of the positive electrode layer 23, known deposition methods, such as various kinds of PVD or various kinds of CVD, may be used; however, in terms of production efficiency, it is desirable to use the sputtering method.

### (Positive Electrode Collector Layer)

The positive electrode collector layer 24 is not particularly limited as long as being a solid thin film having electron conductivity, and it is possible to use conductive materials containing, for example, metals such as titanium (Ti), aluminum (Al), copper (Cu), platinum (Pt) or gold (Au), or alloys of these metals. In the exemplary embodiment, as the positive electrode collector layer 24, titanium (Ti) was used.

The thickness of the positive electrode collector layer 24 can be set at, for example, 5 nm or more and 50 μm or less. When the thickness of the positive electrode collector layer 24 is less than 5 nm, the power collection function is deteriorated, to thereby become impractical. On the other hand, when the thickness of the positive electrode collector layer 24 exceeds 50 μm, it takes too much time to form the layer, and thereby, the productivity is deteriorated. In the exemplary embodiment, the thickness of the positive electrode collector layer 24 was set at 200 nm.

Moreover, as the manufacturing method of the positive electrode layer 24, known deposition methods, such as various kinds of PVD or various kinds of CVD, may be used; however, in terms of production efficiency, it is desirable to use the sputtering method.

### [Configuration of Shell]

The shell 200 includes the laminated film 30 formed by laminating plural layers. In the shell 200, one of the surfaces (hereinafter, referred to as an inside surface) of the laminated film 30 faces a formation surface side of the substrate 10 on which the battery part 20 is formed. Then, in the shell 200, the inside surface of the laminated film 30 and the formation surface of the substrate 10 on which the battery part 20 is formed are thermally adhered over an entire circumference of the battery part 20 via a thermo-adhesive resin layer 35 (details thereof will be described later) provided to the laminated film 30, and thereby the battery part 20 is sealed. At this time, one end of the surface of the substrate 10 in the battery unit 100 (the right end in FIG. 1A) is exposed to the outside without being covered with the shell 200. In contrast thereto, on the back surface of the lithium-ion rechargeable battery 1, the substrate 10 is exposed all over the surface. However, as needed, an insulating film may be attached to all over the back surface of the substrate 10. Here, in the exemplary embodiment, the substrate 10 and the laminated film 30 function as a sealing part.

Moreover, it may be possible that the front surface and the side surface of the substrate 10 are not exposed and all over the surfaces are covered with the shell 200. At this time, as needed, the insulating film may be attached to a part of the back surface of the substrate 10.

### [Laminated Film]

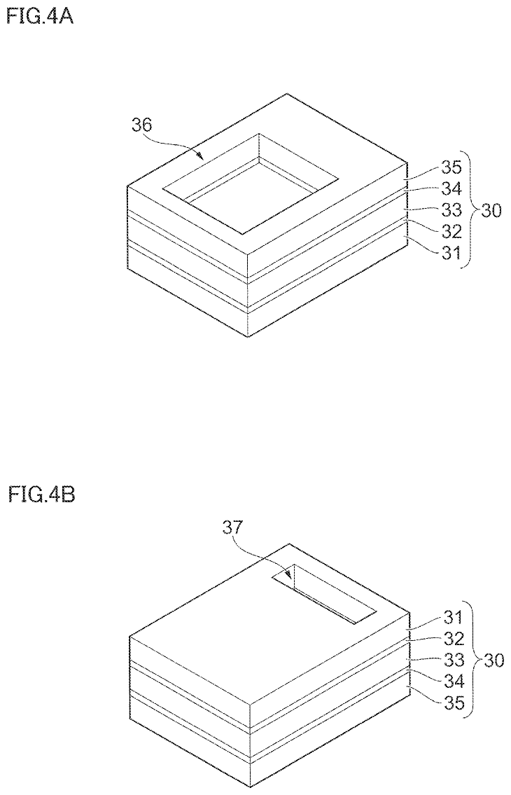

FIGS. 4A and 4B show diagrams for illustrating a configuration of the laminated film 30 in the exemplary embodiment. Here, FIG. 4A shows a perspective view of the inside surface that faces the battery unit 100 when the lithium-ion rechargeable battery 1 is configured, and FIG. 4B shows a perspective view of an outside surface that does not face the battery unit 100 when the lithium-ion rechargeable battery 1 is configured. Hereinafter, the configuration of the laminated film 30 will be described with reference to FIGS. 4A and 4B in addition to FIGS. 1A to 3B.

The laminated film 30 is configured by laminating a heat-resistant resin layer 31, an outside adhesion layer 32, a metal layer 33, an inside adhesion layer 34 and a thermo-adhesive resin layer 35 in this order in a film-like shape. In other words, the laminated film 30 is configured by bonding the heat-resistant resin layer 31, the metal layer 33 and the thermo-adhesive resin layer 35 via the outside adhesion layer 32 and the inside adhesion layer 34.

Moreover, on a formation surface (an inside surface) side of the laminated film 30, on which the thermo-adhesive resin layer 35 is formed, there is provided an inside exposed part 36 where a part of one of surfaces (an inside surface) of the metal layer 33 is exposed due to absence of the thermo-adhesive resin layer 35 and the inside adhesion layer 34. Here, the inside exposed part 36 serves as a portion for housing the battery part 20 of the battery unit 100.

Further, on a formation surface (an outside surface) side of the laminated film 30, on which the heat-resistant resin layer 31 is formed, there is provided an outside exposed part 37 where a part of the other surface (an outside surface) of the metal layer 33 is exposed due to absence of the outside adhesion layer 32 and the heat-resistant resin layer 31.

Next, each constituent of the laminated film 30 will be described in more detail.

### (Heat-Resistant Resin Layer)

The heat-resistant resin layer 31 is the outermost layer in the shell 200, and a heat-resistant resin, which has high resistance to sticking, abrasion or the like from the outside, and is not melted at the adhesive temperature in thermally adhering the thermo-adhesive resin layer 35, is used. Here, as the heat-resistant resin layer 31, it is preferable to use a heat-resistant resin having a melting point not less than 10° C. higher than a melting point of a thermo-adhesive resin constituting the thermo-adhesive resin layer 35, and particularly preferable to use a heat-resistant resin having a melting point not less than 20° C. higher than the melting point of the thermo-adhesive resin. Moreover, in the exemplary embodiment, as will be described later, the metal layer 33 also serves as the positive electrode of the battery part 20; therefore, in terms of safety, an insulating resin having high electrical resistance value is used as the heat-resistant resin layer 31.

As the heat-resistant resin layer 31, though not being particularly limited, examples thereof include polyamide films or polyester films, and oriented films thereof are preferably used. Among them, in terms of moldability and strength, it is particularly preferable to use a biaxially oriented polyamide film, a biaxially oriented polyester film or a multi-layered film containing these films, and further, it is preferable to use a multi-layered film made by bonding the biaxially oriented polyamide film and the biaxially oriented polyester film. As the polyamide film, though not being particularly limited, examples thereof include a 6-polyamide film, a 6,6-polyamide film and an MXD polyamide film. Moreover, as the biaxially oriented polyester film, examples include a biaxially oriented polybutylene terephthalate (PBT) film and a biaxially oriented polyethylene terephthalate (PET) film. In the exemplary embodiment, as the heat-resistant resin layer 31, a PET film (the melting point: 260° C.) was used.

The thickness of the heat-resistant resin layer 31 can be set at 9 μm or more to 50 μm or less. When the thickness of the heat-resistant resin layer 31 is less than 9 μm, it becomes difficult to secure the sufficient strength as the shell 200 of the battery part 20. On the other hand, when the thickness of the heat-resistant resin layer 31 exceeds 50 μm, since the battery becomes thick, it is not preferable. Moreover, the manufacturing costs are increased. In the exemplary embodiment, the thickness of the heat-resistant resin layer 31 was set at 12 μm.

### (Outside Adhesion Layer)

The outside adhesion layer 32 adheres the heat-resistant resin layer 31 and the metal layer 33. As the outside adhesion layer 32, for example, it is preferable to use two-pack curable type polyester-urethane resin by polyester resin as a base resin and polyfunctional isocyanate compound as a curing agent, or an adhesive agent containing polyether-urethane resin. In the exemplary embodiment, as the outside adhesion layer 32, the two-pack curable type polyester-urethane adhesive agent was used.

### (Metal Layer)

The metal layer 33 has a role, when the shell 200 is configured by using the laminated film 30, in preventing oxygen, moisture or the like from entering the battery part 20, which is disposed inside the shell 200, from the outside thereof (barriering the battery part 20). Moreover, as will be described later, the metal layer 33 further has a role as a positive internal electrode, and a role as a positive external electrode of the battery part 20, the positive external electrode being electrically connected to a load provided outside (not shown).

As the metal layer 33, though not being particularly limited, for example, aluminum foil, copper foil, nickel foil, stainless steel foil, clad foil thereof, annealed foil or unannealed foil thereof and the like are preferably used. Moreover, metallic foil, which is obtained by plating with conductive metals, such as nickel, tin, copper, chrome and the like, may be used. In the exemplary embodiment, as the metal layer 33, aluminum foil made of the A8021H-O material prescribed by JIS H4160 was used.

The thickness of the metal layer 33 can be set at 5 μm or more and 200 μm or less. When the thickness of the metal layer 33 is less than 5 μm, the electrical resistance value when being used as an electrode is increased. On the other hand, when the thickness of the metal layer 33 exceeds 200 μm, there is a possibility that heat is dispersed in thermal adhesion and results in insufficient thermal adhesion. Here, from the standpoint of increasing the mechanical strength of the lithium-ion rechargeable battery 1, it is preferable that the above-described substrate 10 is thicker than the metal layer 33. In the exemplary embodiment, the thickness of the metal layer 33 was set at 20 μm.

### (Inside Adhesion Layer)

The inside adhesion layer 34 adheres the metal layer 33 and the thermo-adhesive resin layer 35. As the inside adhesion layer 34, it is preferable to use an adhesive agent made of, for example, a polyurethane adhesive agent, an acrylic adhesive agent, an epoxy adhesive agent, a polyolefine adhesive agent, an elastomer adhesive agent, a fluorine adhesive agent or the like. Among them, it is preferable to use the acrylic adhesive agent or the polyolefine adhesive agent; in this case, the barrier properties of the laminated film 30 against water vapor can be improved. Moreover, it is preferable to use an adhesive agent of acid-denaturated polypropylene, polyethylene or the like. In the exemplary embodiment, as the inside adhesion layer 34, the polyurethane adhesive agent was used.

### (Thermo-Adhesive Resin Layer)

The thermo-adhesive resin layer 35 is the innermost layer in the shell 200, and, as the thermo-adhesive resin layer 35, a resin having high resistance to the materials constituting the respective layers of the battery part 20 and melted at the above-described adhesive temperature, to thereby adhere to the substrate 10, is used. Moreover, in the exemplary embodiment, as described above, the metal layer 33 also serves as the positive electrode of the battery part 20; therefore, in terms of safety, an insulating resin having high electrical resistance value is used as the thermo-adhesive resin layer 35.

As the thermo-adhesive resin layer 35, though not being particularly limited, for example, polyethylene, polypropylene, olefin copolymer, acid denaturation and ionomer thereof and so forth are preferably used. Here, examples of the olefin copolymer include: EVA (ethylene vinyl acetate copolymer); EAA (ethylene acrylic acid copolymer); and EMAA (ethylene methacrylic acid copolymer). In the exemplary embodiment, as the heat-resistant resin layer 35, an ionomer film (the melting point: 90° C.) that has low-temperature sealing characteristics and good sealing characteristics with metals was used.

The thickness of the thermo-adhesive resin layer 35 can be set at 20 μm or more and 80 μm or less. When the thickness of the thermo-adhesive resin layer 35 is less than 20 μm, pinholes are likely to be generated. On the other hand, when the thickness of the thermo-adhesive resin layer 35 exceeds 80 μm, since the battery becomes thick, it is not preferable. Moreover, since heat insulation properties are increased, there is a possibility of resulting in insufficient thermal adhesion. In the exemplary embodiment, the thickness of the thermo-adhesive resin layer 35 was set at 30 μm.

### [Electrical Connection Structure in Lithium-Ion Rechargeable Battery]

Here, electrical connection structure in the lithium-ion rechargeable battery 1 of the exemplary embodiment will be described.

First, in the battery part 20, the negative electrode layer 21, the solid electrolyte layer 22, the positive electrode layer 23 and the positive electrode collector layer 24 are electrically connected in this order. Moreover, in the battery unit 100, the substrate 10 and the negative electrode layer 21 of the battery part 20 are electrically connected. Here, one end side of the front surface of the substrate 10 and the back surface thereof are exposed to the outside without being covered with the shell 200; these portions can be electrically connected, as a negative electrode, to the load (not shown) provided outside.

The positive electrode collector layer 24 of the battery part 20 is electrically connected to a portion, of one surface (the inside surface) of the metal layer 33 provided to the laminated film 30, exposed to the inside exposed part 36. Then, a part of the other surface (the outside surface) of the metal layer 33 provided to the laminated film 30 is exposed at the outside exposed part 37 to the outside; the portion can be electrically connected, as a positive electrode, to the load (not shown) provided outside.

Consequently, in this example, the substrate 10 serves as the negative electrode of the lithium-ion rechargeable battery 1, and the metal layer 33 provided to the laminated film 30 serves as the positive electrode of the lithium-ion rechargeable battery 1. Here, the substrate 10 serving as the negative electrode side and the metal layer 33 serving as the positive electrode side are electrically insulated by the thermo-adhesive resin layer 35 provided to the laminated film 30.

### [Operation of Lithium-Ion Rechargeable Battery]

When the lithium-ion rechargeable battery 1 of the exemplary embodiment is to be charged, a negative electrode of a DC power supply is connected to the substrate 10 that functions as the negative electrode collector layer, and a positive electrode of the DC power supply is connected to the positive electrode collector layer 24. Then, the lithium ions constituting the positive-electrode active material in the positive electrode layer 23 are moved to the negative electrode layer 21 through the solid electrolyte layer 22, to be thereby contained in the negative-electrode active material in the negative electrode layer 21.

Moreover, when the lithium-ion rechargeable battery 1 having been charged is to be used (discharged), a negative electrode of a DC load is connected to the substrate 10 that functions as the negative electrode collector layer, and a positive electrode of the DC load is connected to the positive electrode collector layer 24. Then, the lithium ions contained in the negative-electrode active material in the negative electrode layer 21 are moved to the positive electrode layer 23 through the solid electrolyte layer 22, to thereby constitute the positive-electrode active material in the positive electrode layer 23.

### [Method for Manufacturing Lithium-Ion Rechargeable Battery]

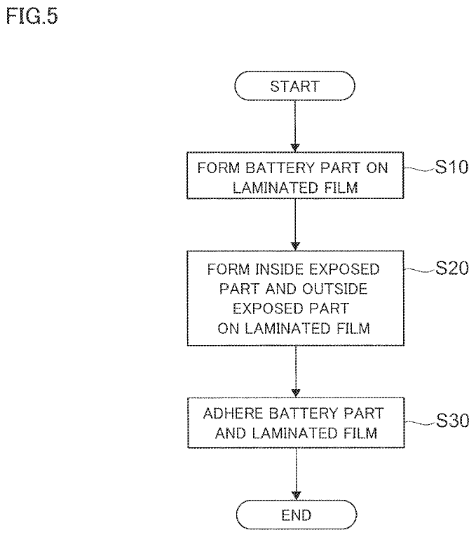

FIG. 5 is a flowchart for illustrating a method for manufacturing the lithium-ion rechargeable battery 1 shown in FIGS. 1A and 1B and so forth.

### (Battery Unit Production Process)

First, the battery part 20 is formed on the front surface of the substrate 10 (step 10). In other words, on the front surface of the substrate 10, the negative electrode layer 21, the solid electrolyte layer 22, the positive electrode layer 23 and the positive electrode collector layer 24 are formed in this order, and thereby the battery unit 100 including the substrate 10 and the battery part 20 is obtained. Note that, here, each of the negative electrode layer 21, the solid electrolyte layer 22, the positive electrode layer 23 and the positive electrode collector layer 24 was produced by using the sputtering method.

### (Laminated Film Exposed Portion Formation Process)

Subsequently, from the laminated film 30 formed by bonding the heat-resistant resin layer 31, the metal layer 33 and the thermo-adhesive resin layer 35 via the outside adhesion layer 32 and the inside adhesion layer 34, a part of the heat-resistant resin layer 31, the outside adhesion layer 32, the inside adhesion layer 34 and the thermo-adhesive resin layer 35 is removed. Consequently, in the laminated film 30, the inside exposed part 36 and the outside exposed part 37 are formed (step 20).

### (Adhesion Process)

Next, for example, into a working box filled with an inert gas, such as N₂ gas or the like, the battery unit 100 and the laminated film 30 are introduced. Then, the positive electrode collector layer 24 provided to the battery part 20 of the battery unit 100 and the inside exposed part 36 provided to the laminated film 30 are caused to face each other.

Thereafter, in a state where the interior of the working box is set to the negative pressure, the thermo-adhesive resin layers 35 in the laminated film 30 and the substrate 10 of the battery unit 100 are adhered to each other all around the outer periphery of the battery part 20 while being pressurized and heated (step 30). Then, by thermally adhering the thermo-adhesive resin layer 35 and the substrate 10, the lithium-ion rechargeable battery 1 provided with the battery unit 100, which includes the substrate 10 and the battery part 20, and the shell 200, which includes the laminated film 30, is obtained.

At this time, the battery unit 100 is in a state in which the substrate 10 and the battery part 20 are joined (integrated) by the sputter deposition. Moreover, the positive electrode collector layer 24 of the battery part 20 and the metal layer 33 of the laminated film 30 are brought into a state of being tightly adhered to each other by thermally adhering the thermo-adhesive resin layers 35 of the laminated film 30 and the substrate 10 under the negative pressure.

### Brief Account of Exemplary Embodiment 1

As described above, according to the exemplary embodiment, with respect to the battery unit 100 configured by forming the battery part 20 on the front surface of the metal substrate 10, the battery part 20 side was covered with the laminated film 30 of the shell 200. In other words, in the exemplary embodiment, together with the laminated film 30 constituting the shell 200, the substrate 10 constituting the battery unit 100 was used to seal the battery part 20. This makes it possible to simplify the configuration of the lithium-ion rechargeable battery 1, as compared to a case in which the battery part 20 is sealed by covering the both surfaces of the substrate 10 in the battery unit 100 with the laminated films 30. Moreover, as a result, it is possible to reduce the thickness of the lithium-ion rechargeable battery 1.

### Others

Note that, in the exemplary embodiment, the configuration in which, the negative electrode layer 21, the solid electrolyte layer 22 and the positive electrode layer 23 are laminated in this order on the substrate 10, is adopted; however, the present invention is not limited thereto. For example, a configuration in which, the positive electrode layer 23, the solid electrolyte layer 22 and the negative electrode layer 21 are laminated on the substrate 10 in this order, may be adopted. Moreover, in this case, a negative electrode collector layer made of a solid thin film having electron conductivity may be provided on the negative electrode layer 21.

### Modified Example of Exemplary Embodiment 1

In the lithium-ion rechargeable battery 1 of Exemplary embodiment 1, the battery part 20 included the positive electrode collector layer 24; however, the positive electrode collector layer 24 is not essential.

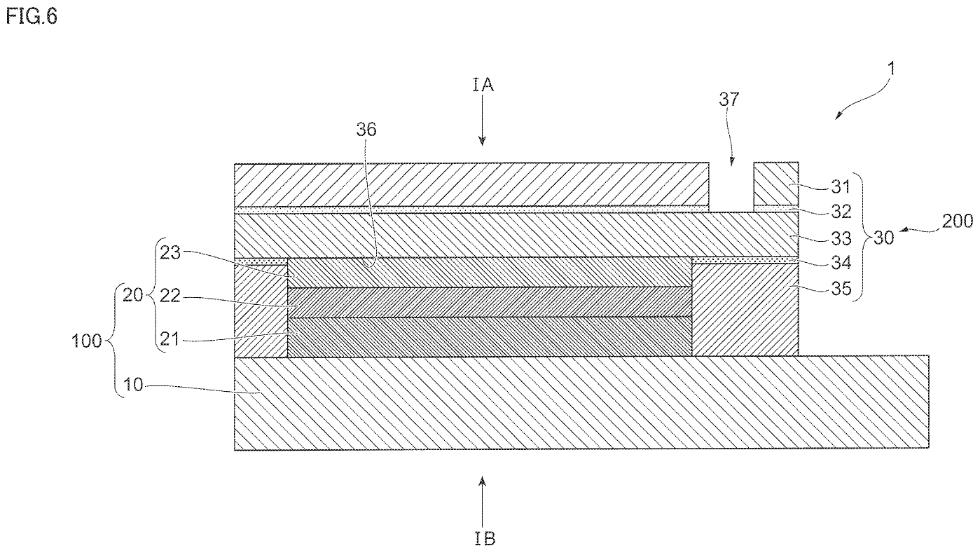

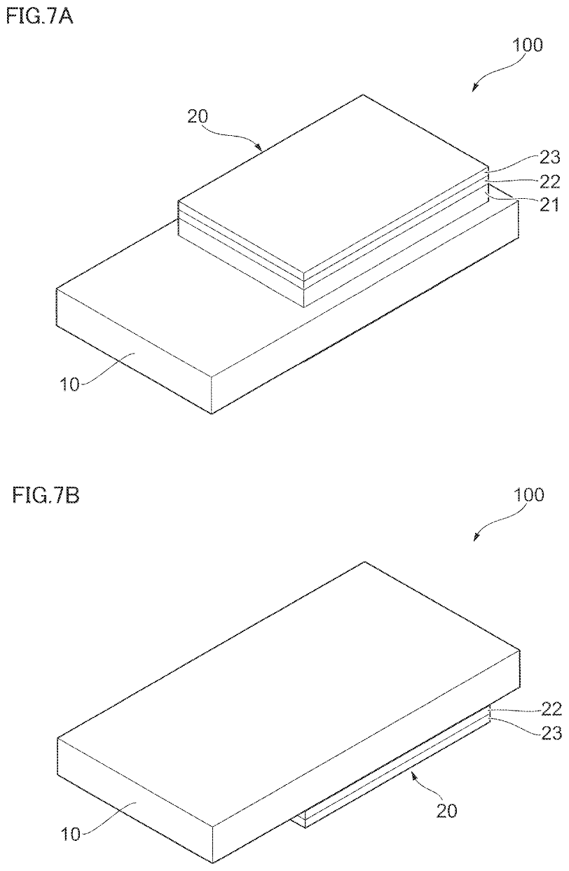

FIG. 6 is a diagram for illustrating a modified example of Exemplary embodiment 1, which is a II-II cross-sectional view of FIG. 1A. Moreover, FIGS. 7A and 7B are perspective views of the battery unit 100 in the modified example of Exemplary embodiment 1.

In the modified example of Exemplary embodiment 1, the battery part 20 constituting the battery unit 100 includes: the negative electrode layer 21 laminated on one surface of the substrate 10; the solid electrolyte layer 22 laminated on the negative electrode layer 21; and the positive electrode layer 23 laminated on the solid electrolyte layer 22. Then, the positive electrode collector layer 23 positioned on the other end portion of the battery part 20 (the upper side in FIG. 6) is in direct contact with the metal layer 33 exposed at the inside exposed part 36 of the laminated film 30.

By adopting such a configuration, as compared to the configuration described in Exemplary embodiment 1, it is possible to simplify the structure of the lithium-ion rechargeable battery 1.

However, as in the modified example, when the configuration in which the battery part 20 is not provided with the positive electrode collector layer 24 is adopted, it is preferable to use, as the positive electrode layer 23, LiNiO₂ having contact resistance with metal, which is smaller than that of Li_{1.5}Mn₂O₄.

### Exemplary Embodiment 2

In Exemplary embodiment 1, the metal substrate 10 having conductivity was used, and thereby the substrate 10 functioned as the negative electrode collector layer of the battery part 20. In contrast thereto, the exemplary embodiment separately provides the negative electrode collector layer, as well as using an insulating substrate 10. Note that, in the exemplary embodiment, those similar to Exemplary embodiment 1 are assigned with same reference signs, and detailed descriptions thereof will be omitted.

### [Configuration of Lithium-Ion Rechargeable Battery]

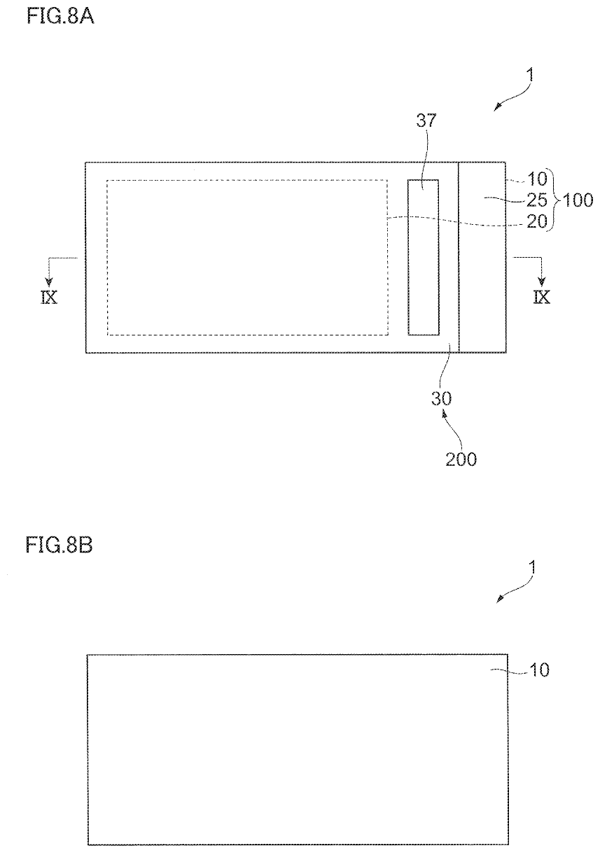

FIGS. 8A and 8B show diagrams for illustrating an overall configuration of the lithium-ion rechargeable battery 1 to which Exemplary embodiment 2 is applied. Here, FIG. 8A is a diagram in which the lithium-ion rechargeable battery 1 is viewed from the front (front surface), and FIG. 8B is a diagram in which the lithium-ion rechargeable battery 1 is viewed from the back (back surface).

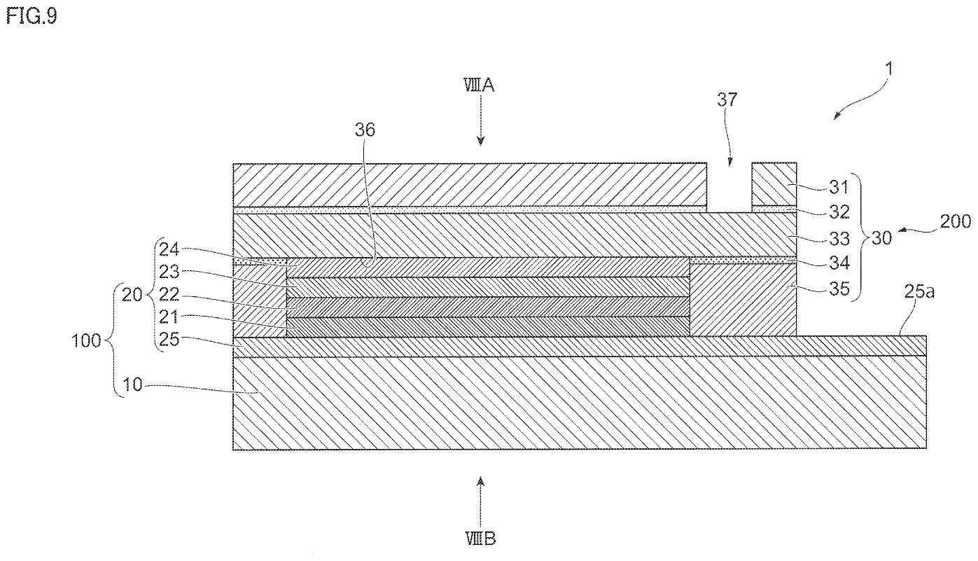

Moreover, FIG. 9 shows a IX-IX cross-sectional view of FIG. 8A. Note that FIG. 8A is a diagram viewing FIG. 9 from the VIIIA direction, and FIG. 8B is a diagram viewing FIG. 9 from the VIIIB direction.

The lithium-ion rechargeable battery 1 of the exemplary embodiment also includes: the battery unit 100 including the battery part 20 that performs charge and discharge using lithium ions; and the shell 200 that seals the battery part 20 against outside air or the like by housing the battery part 20 in the interior thereof.

### [Configuration of Battery Unit]

The battery unit 100 includes the substrate 10 and the battery part 20 provided to one surface (referred to as a front surface) of the substrate 10. The battery unit 100 of the exemplary embodiment also has the configuration integrating the substrate 10 and the battery part 20.

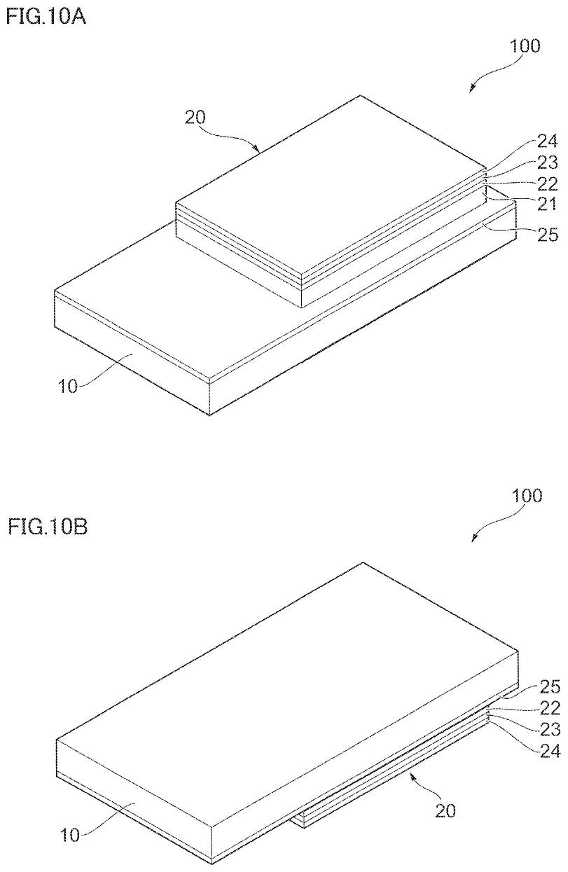

FIGS. 10A and 10B show diagrams for illustrating the configuration of the battery unit 100 in the exemplary embodiment: FIG. 10A shows a perspective view that is viewed from the front side (in FIG. 9, from above); and FIG. 10B shows a perspective view that is viewed from the back side (in FIG. 9, from below). Hereinafter, the configuration of the battery unit 100 will be described with reference to FIGS. 10A and 10B in addition to FIGS. 8A, 8B and 9.

### [Substrate]

In the exemplary embodiment, the substrate 10 was configured with a plate material made of an inorganic material having insulation properties. Here, as the substrate 10 of the exemplary embodiment, for example, a polycrystalline material, such as alumina or zirconia, an amorphous material, such as silica glass, a monocrystalline material, such as sapphire, or the like can be used.

The thickness of the substrate 10 can be set at 50 μm or more and 500 μm or less. When the thickness of the substrate 10 is less than 50 μm, it becomes difficult to deal therewith in the sputter deposition. On the other hand, when the thickness of the substrate 10 exceeds 500 μm, a volume energy density and a weight energy density are reduced by the increases in the thickness and the weight of the battery. In the exemplary embodiment, the thickness of the substrate 10 was set at 300 μm.

### [Battery Part]

The battery part 20 includes: a negative electrode collector layer 25 laminated on the front surface (the upper side in FIG. 9) of the substrate 10; the negative electrode layer 21 laminated on the negative electrode collector layer 25; the solid electrolyte layer 22 laminated on the negative electrode layer 21; the positive electrode layer 23 laminated on the solid electrolyte layer 22; and the positive electrode collector layer 24 laminated on the positive electrode layer 23. Here, the negative electrode collector layer 25 positioned on one end portion of the battery part 20 (the lower side in FIG. 9) is in contact with the front surface of the substrate 10. In contrast thereto, the positive electrode collector layer 24 positioned on the other end portion of the battery part 20 (the upper side in FIG. 9) is in contact with a metal layer 33 provided to a laminated film 30, which will be described later. Note that, as the negative electrode layer 21, the solid electrolyte layer 22, the positive electrode layer 23 and the positive electrode collector layer 24 constituting the battery part 20, the ones that are the same as those described in Exemplary embodiment can be used; therefore, detailed description thereof will be omitted.

### (Negative Electrode Collector Layer)

The negative electrode collector layer 25 is not particularly limited as long as being a solid thin film and having electron conductivity, and it is possible to use conductive materials containing, for example, metals such as titanium (Ti), aluminum (Al), copper (Cu), platinum (Pt) or gold (Au), or alloys of these metals. In the exemplary embodiment, as the negative electrode collector layer 25, titanium (Ti) was used.

The thickness of the negative electrode collector layer 25 can be set at, for example, 5 nm or more and 50 μm or less. When the thickness of the negative electrode collector layer 25 is less than 5 nm, the power collection function is deteriorated, to thereby become impractical. On the other hand, when the thickness of the negative electrode collector layer 25 exceeds 50 μm, it takes too much time to form the layer, and thereby, the productivity is deteriorated. In the exemplary embodiment, the thickness of the negative electrode collector layer 25 was set at 200 nm.

Moreover, as the manufacturing method of the negative electrode collector layer 25, known deposition methods, such as various kinds of PVD or various kinds of CVD, may be used; however, in terms of production efficiency, it is desirable to use the sputtering method.

Here, the negative electrode collector layer 25 is formed (laminated) all over the region of the front surface of the substrate 10. In contrast thereto, the negative electrode layer 21 to the positive electrode collector layer 24 constituting the battery part 20 together are formed (laminated) on a part of the front surface of the negative electrode collector layer 25.

Then, in the exemplary embodiment, the lithium-ion rechargeable battery 1 is configured by bonding the battery unit 100 and the shell 200 made of the laminated film 30 to expose a part of the negative electrode collector layer 25 provided to the front surface of the substrate 10 to the outside. As a result, the part of the negative electrode collector layer 25 is exposed to the outside, to thereby serve as an exposed portion 25a used for electrical connection with the outside.

### Brief Account of Exemplary Embodiment 2

As described above, according to the exemplary embodiment, in addition to the effects described in Exemplary embodiment 1, the hardness of the lithium-ion rechargeable battery 1 can be higher and the weight thereof can be lighter because the substrate 10 is configured with an inorganic insulating material, not with a metal. Moreover, when the electrical leakage toward the case housing the lithium-ion rechargeable battery 1 is regarded problematic, insulation can be provided to the battery side by adopting the configuration of the exemplary embodiment.

### Others

Note that, as same as the above-described modified example of Exemplary embodiment 1, also in the exemplary embodiment, the positive electrode collector layer 24 is not essential; the positive electrode layer 23 of the battery part 20 and the metal layer 33 of the laminated film 30 may be brought into direct contact with each other.

### REFERENCE SIGNS LIST

1 Lithium-ion rechargeable battery
10 Substrate
20 Battery part
21 Negative electrode layer
22 Solid electrolyte layer
23 Positive electrode layer
24 Positive electrode collector layer
30 Laminated film
31 Heat-resistant resin layer
32 Outside adhesion layer
33 Metal layer
34 Inside adhesion layer
35 Thermo-adhesive resin layer
36 Inside exposed part
37 Outside exposed part
100 Battery unit
200 Shell

1-5. (canceled)

6. A lithium-ion rechargeable battery comprising:
a battery part including a positive electrode layer containing a positive-electrode active material, a negative electrode layer containing a negative-electrode active material, and a solid electrolyte layer containing an inorganic solid electrolyte having lithium-ion conductivity, the solid electrolyte layer being provided between the positive electrode layer and the negative electrode layer;
a substrate on one surface of which the battery part is placed; and
a laminated film including a metal layer and a resin layer laminated on the metal layer that is disposed to face the one surface of the substrate, the laminated film sealing the battery part with the substrate in a state in which the metal layer and the battery part are brought into conduction.

7. The lithium-ion rechargeable battery according to claim 6, wherein the substrate is thicker than the metal layer of the laminated film.

8. The lithium-ion rechargeable battery according to claim 6, wherein a part of the metal layer in the laminated film is exposed without being covered with the resin layer.

9. The lithium-ion rechargeable battery according to claim 7, wherein a part of the metal layer in the laminated film is exposed without being covered with the resin layer.

10. The lithium-ion rechargeable battery according to claim 6, wherein the positive electrode layer provided to the battery part and the metal layer provided to the laminated film are in direct contact with each other.

11. The lithium-ion rechargeable battery according to claim 7, wherein the positive electrode layer provided to the battery part and the metal layer provided to the laminated film are in direct contact with each other.

12. The lithium-ion rechargeable battery according to claim 8, wherein the positive electrode layer provided to the battery part and the metal layer provided to the laminated film are in direct contact with each other.

13. The lithium-ion rechargeable battery according to claim 9, wherein the positive electrode layer provided to the battery part and the metal layer provided to the laminated film are in direct contact with each other.

14. A lithium-ion rechargeable battery comprising:
a battery part including: a positive electrode layer containing a positive-electrode active material; a negative electrode layer containing a negative-electrode active material; and a solid electrolyte layer containing an inorganic solid electrolyte having lithium-ion conductivity, the solid electrolyte layer being provided between the positive electrode layer and the negative electrode layer; and
a sealing part including: a substrate on one surface of which the battery part is placed, the substrate being integrated with the battery part; and a laminated film formed by laminating a metal layer and a resin layer, the sealing part sealing the battery part with the substrate by holding the battery part with the substrate in a state in which the metal layer and the battery part are brought into conduction.
